(19) United States
(12) Patent Application Publication
(10) Pub. No.: US 2015/0032431 A1
(43) Pub. Date: Jan. 29, 2015

(54) Systems and Methods for Assisted Property Modeling

(71) Applicant: Landmark Graphics Corporation, Houston, TX (US)

(72) Inventors: Genbao Shi, Sugar Land, TX (US); Jeffrey Marc Yarus, Houston, TX (US); Richard L. Chambers, Bixby, OK (US); Marko Maucec, Englewood, CO (US)

(21) Appl. No.: 14/345,116

(22) PCT Filed: Jan. 6, 2012
(86) PCT No.: PCT/US12/20435

§ 371 Date: Oct. 15, 2014

Related U.S. Application Data
(60) Provisional application No. 61/535,855, filed on Sep. 16, 2011.

(51) Int. Cl. G01V 99/00

(52) U.S. Cl. CPC G01V 99/005
USPC 703/6

(57) ABSTRACT

Systems and methods for updating a property map during conditional simulation or unconditional simulation using interactive azimuth guidelines, well data and/or variogram parameters.

### CROSS-REFERENCE TO RELATED APPLICATIONS

This application claims the priority of U.S. Patent Application Ser. No. 61/535,855, filed on Sep. 16, 2011, which is incorporated herein by reference.

### STATEMENT REGARDING FEDERALLY SPONSORED RESEARCH

Not applicable.

### FIELD OF THE INVENTION

The present invention generally relates to assisted property modeling. More particularly, the invention relates to updating a property map during conditional simulation or unconditional simulation using interactive azimuth guidelines, user-defined well data (pseudo-wells) and/or variogram parameters.

### BACKGROUND OF THE INVENTION

Various systems and methods are known that offer the ability to integrate varying azimuthal data through the input of a vector grid and properties from well data.

These systems however, do not allow the user to interactively draw azimuth guidelines of any shape to rapidly create simple to complex vector fields, apply them to regionalized properties (petrophysical properties) and display them in a map view, honoring well data (conditional simulation or interpolation), or not honoring well data (unconditional simulation). In addition, these existing systems do not provide tools with a number of different underlying methods including kriging, conditional simulation, collocated cokriging and collocated cosimulation for both two-dimensional (“2-D”) and three-dimensional (“3-D”) operations.

In operation, the prior art mapping systems and methods suffer from various limitations. For example, conventional mapping systems utilize algorithms assuming isotropy, and they rely on well data, seismic data, and geostatistics using a spatial model as illustrated by the property map 100A in FIG. 1A. The same mapping systems may also impose a single direction of continuity as illustrated by the single direction of continuity 102B on the property map 100B in FIG. 1B.

Vector input gives rise to various shortcomings. Mapping algorithms often fail to capture the complex directionality desired, or the trend maps used to guide the directionality are too limited. In particular, more complicated patterns are imposed by introducing second data via a “grid” or set of detailed inputs as illustrated by the property map 200 in FIG. 2. The resulting product becomes difficult and time-consuming to construct and edit and is rigid and inflexible. Changes require new grids, which also take time to construct. Alternatively, if painting, then painting patterns do not allow for internal changes in continuity directions local to the object painted.

### SUMMARY OF THE INVENTION

The present invention therefore, meets the above needs and overcomes one or more deficiencies in the prior art by providing systems and methods for updating a property map during conditional simulation or unconditional simulation using interactive azimuth guidelines, user-defined well data (pseudo-wells) and/or variogram parameters.

In one embodiment, the present invention includes a method for updating a property map during a simulation, which comprises: i) selecting an algorithm to update the property map based on a conditional simulation or unconditional simulation; ii) selecting a variogram parameter to update the property map; iii) updating the property map using the algorithm and the variogram parameter, the updated property map representing a new property map; iv) rendering an image of the new property map; v) drawing an azimuth guideline on the new property map or adding user-defined well data to the new property map; vi) updating the new property map using one of the algorithm, the variogram parameter and the azimuth guideline and the user-defined well data; and vii) rendering an image of the updated new property map.

In another embodiment, the present invention includes a non-transitory program carrier device tangibly carrying computer executable instructions for updating a property map during a simulation, the instructions being executable to implement: i) selecting an algorithm to update the property map based on a conditional simulation or unconditional simulation; ii) selecting a variogram parameter to update the property map; iii) updating the property map using the algorithm and the variogram parameter, the updated property map representing a new property map; iv) rendering an image of the new property map; v) drawing an azimuth guideline on the new property map or adding user-defined well data to the new property map; vi) updating the new property map using one of the algorithm, the variogram parameter and the azimuth guideline and the user-defined well data; and vii) rendering an image of the updated new property map.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings in which like elements are referenced with like reference numerals, and in which:

FIG. 1A illustrates a property map using variogram parameters without a global azimuth or anisotropy ratio.

FIG. 1B illustrates the property map in FIG. 1A using variogram parameters with a global azimuth or anisotropy ratio.

FIG. 2 illustrates a property map with multiple azimuths.

FIG. 3 is a flow diagram illustrating one embodiment of a method for implementing the present invention.

FIG. 4A illustrates azimuth guidelines drawn on the property map in FIG. 2 as a result of step 320 in FIG. 3.

FIG. 4B illustrates an updated display of the property map in FIG. 4A as a result of step 326 in FIG. 3.

FIG. 5 illustrates an updated display of the property map in FIG. 1B as a result of step 326 in FIG. 3 after the addition of four azimuth guidelines.

FIG. 6 illustrates an updated display of the property map in FIG. 5 as a result of step 326 in FIG. 3 after the addition of three well user-defined well data points.

FIG. 7 illustrates an updated display of the property map in FIG. 1B as a result of step 326 in FIG. 3 after the addition of four azimuth guidelines and one user-defined well data point.

FIG. 8 illustrates an updated display of the property map in FIG. 1B as a result of step 326 in FIG. 3 after the addition of a single azimuth guideline and multiple user-defined well data points.

FIG. 9 is a block diagram illustrating one embodiment of a system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present invention may be applied in the oil and gas industry, it is not limited thereto and may also be applied in other industries to achieve similar results.

The present invention does away with the need to provide static input, a fixed grid or lattice, for the purpose of identifying specific vector information at a given x,y,z, location. The information is provided in order to allow the directionality of property continuities to vary with distance over the model area. This has historically been a tedious operation requiring advanced preparation and repetition each time the user changed the underlying vector field. The present invention, instead, provides the user with a graphic interface that allows directional patterns to be sketched on the interface causing the underlying vector field to conform. In other words, a new data set may be created by drawing one or more lines (vectors) with a user input device, such as a mouse, tablet, or, in the case of touch-sensitive media—a finger. The result is displayed as a property map where the directional continuities precisely follow the sketched patterns and wherein the image can be refreshed and redrawn rapidly, if not instantly. Moreover, the pseudo-well control points may be added to further constrain the underlying patterns or test the effect of the simulation on the potential drill site.

The present invention may be implemented directly on any user-computing device, including an iPad®, through an application program interface or cloud computing.

### Method Description

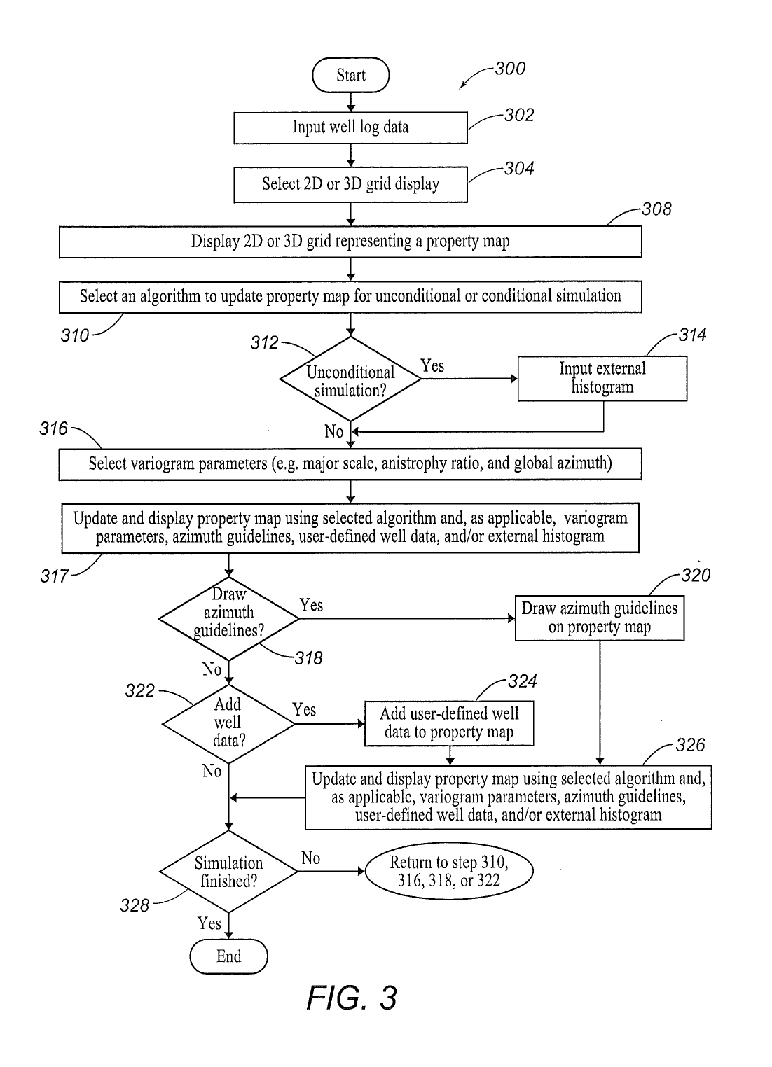

Referring now to FIG. 3, a flow diagram illustrates one embodiment of a method 300 for implementing the present invention.

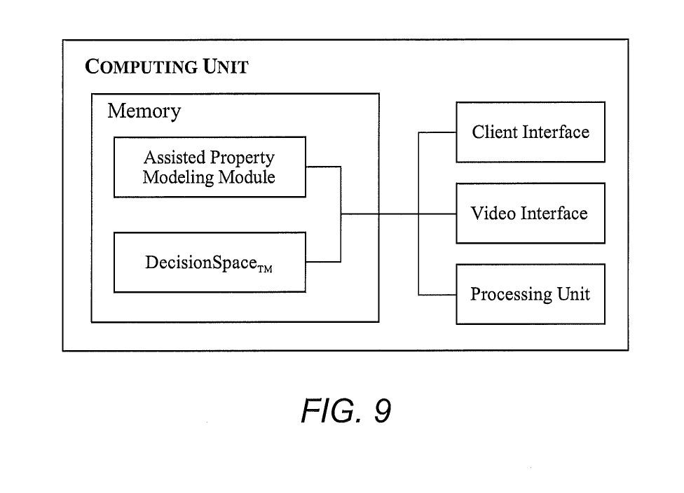

In step 302, well log data is input, which may include porosity, permeability and/or facies, with well control points, using the client interface and/or the video interface described in reference to FIG. 9.

In step 304, a 2D or 3D grid display is selected for displaying the well log data using the client interface and/or the video interface described in reference to FIG. 9. Exemplary displays may include a 2D grid display of a surface or a 3D grid display of a reservoir.

In step 308, the 2D or 3D grid is displayed as a property map using techniques well known in the art and/or the video interface described in reference to FIG. 9.

In step 310, an algorithm is selected to update the property map for conditional simulation or unconditional simulation using the client interface and/or the video interface described in reference to FIG. 9. Selection of the algorithm may be based on a subjective determination of the type of simulation preferred, including whether kriging, co-kriging or collocated co-kriging are preferred for conditional simulation. The algorithm may condition the simulation to the well log data thus, honoring the well log data when conditional simulation is preferred or it may not honor the well log data when unconditional simulation is preferred.

In step 312, the method 300 determines if the algorithm selected in step 310 is for unconditional simulation. If the algorithm selected in step 310 is not for unconditional simulation, then the method 300 proceeds to step 316. If the algorithm selected in step 310 is for unconditional simulation, then the method 300 proceeds to step 314.

In step 314, an external histogram is input using the client interface and/or the video interface described in reference to FIG. 9.

In step 316, variogram parameters are selected using the client interface and/or the video interface described in reference to FIG. 9. The parameters may include a major scale, an anisotrophy ratio, and a global azimuth for the variogram. The parameters may be selected by use of an existing variogram, modification of an existing variogram, or selection of new variogram parameters.

In step 317, the property map is automatically updated and displayed using the algorithm selected in step 310 and, as applicable, the variogram parameters selected in step 316, the azimuth guidelines drawn in step 320, the user-defined well data added during step 324 and/or the external histogram input during step 314. During the first iteration of the method 300, step 317 updates and displays the property map using only the algorithm selected in step 310, the variogram parameters selected in step 316 and the external histogram input during step 314 (for only unconditional simulation). During subsequent iterations of the method 300, step 317 updates and displays the property map using the algorithm selected in step 310, the variogram parameters selected in step 316, the external histogram input during step 314 (for only unconditional simulation), the azimuth guidelines, if any, drawn in step 320 and the user-defined well data, if any, added during step 324.

In step 318, the method 300 determines if azimuth guidelines are preferred based upon the results of the property map displayed in step 317. If azimuth guidelines are not preferred, then the method 300 proceeds to step 322. If azimuth guidelines are preferred, then the method 300 proceeds to step 320.

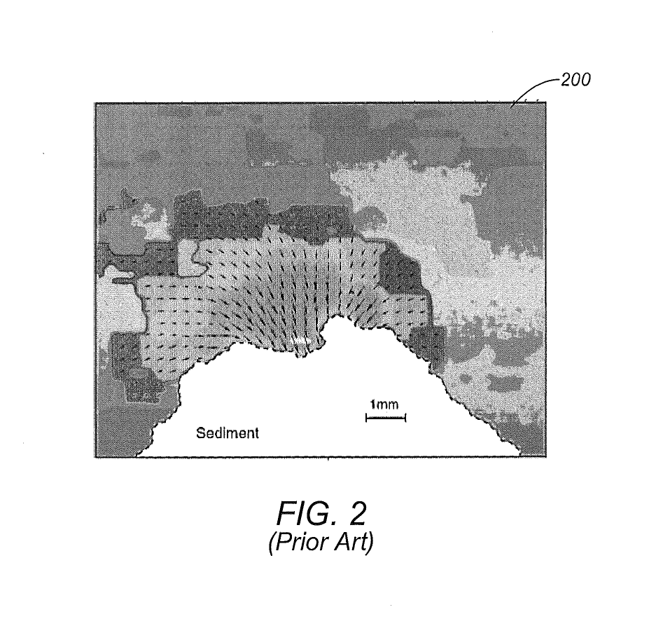

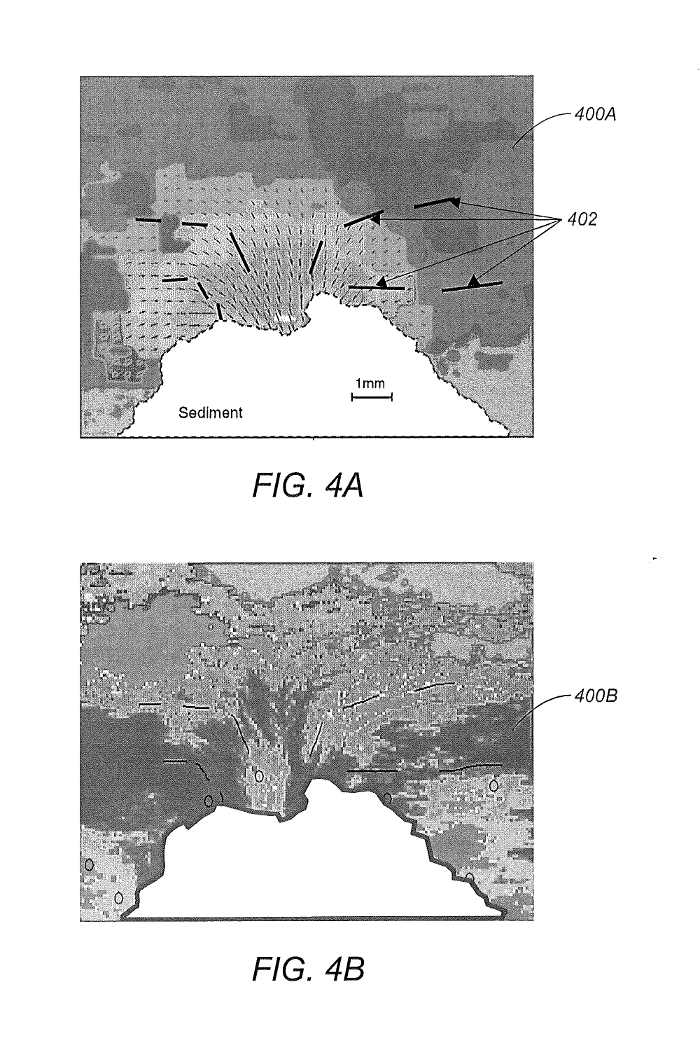

In step 320, azimuth guidelines are drawn on the property map displayed in step 317 using the client interface and/or the video interface described in reference to FIG. 9. In FIG. 4A, the property map 400A illustrates azimuth guidelines 402 that were drawn on the property map in FIG. 2 as a result of this step. Each azimuth guideline may be curvilinear, which imposes directionality.

In step 322, the method 300 determines if user-defined well data is preferred based on the results of the property map displayed in step 317. If user-defined well data is not preferred, then the method 300 proceeds to step 328. If user-defined well data is preferred, then the method 300 proceeds to step 324.

In step 324, user-defined well data is added to the property map displayed in step 317 using the client interface and/or the video interface described in reference to FIG. 9.

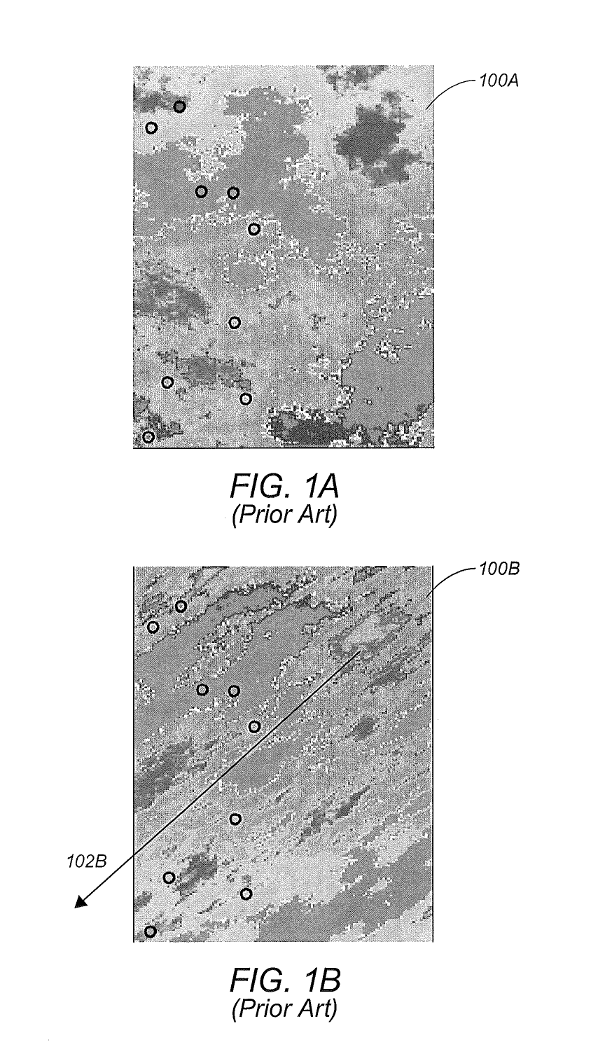

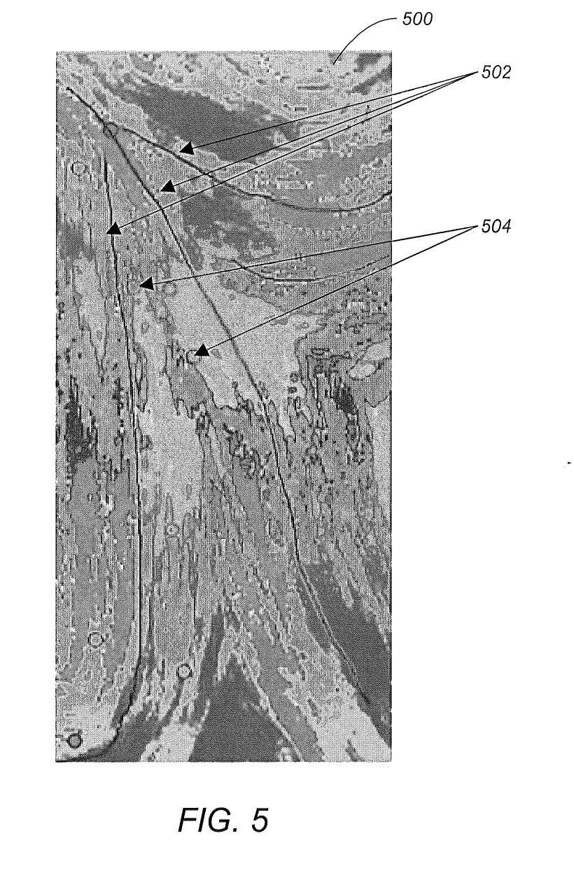

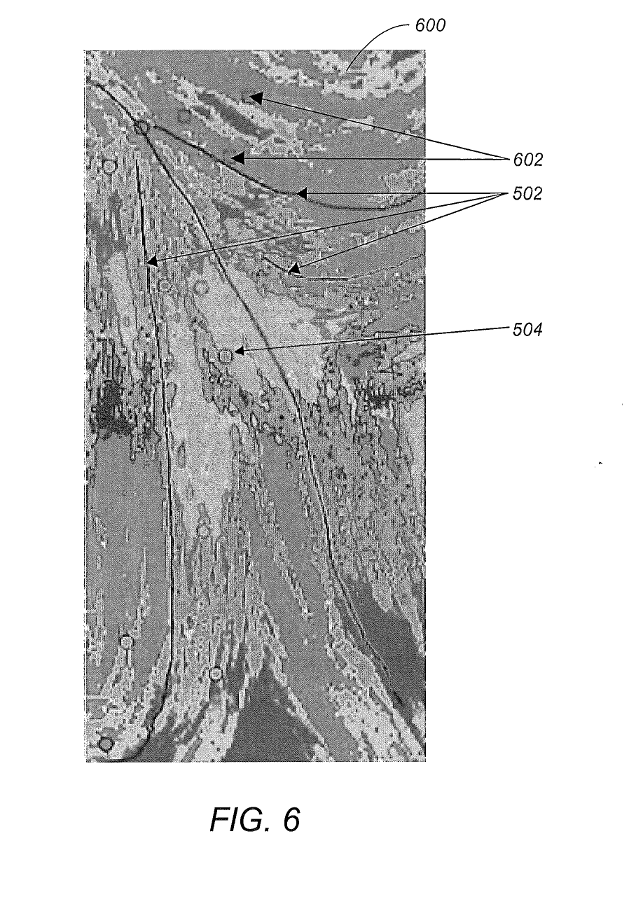

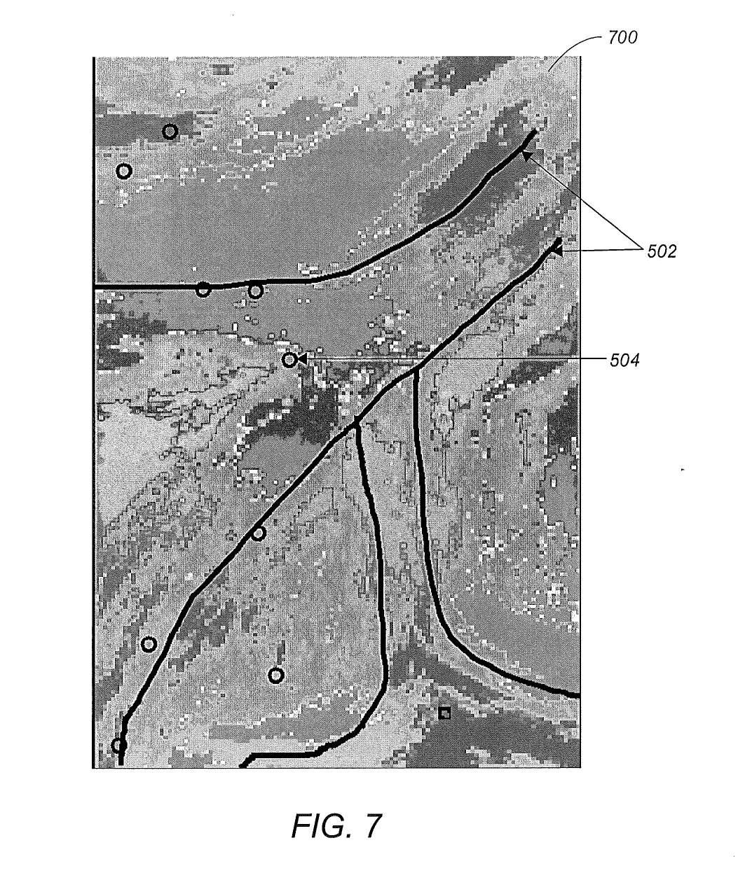

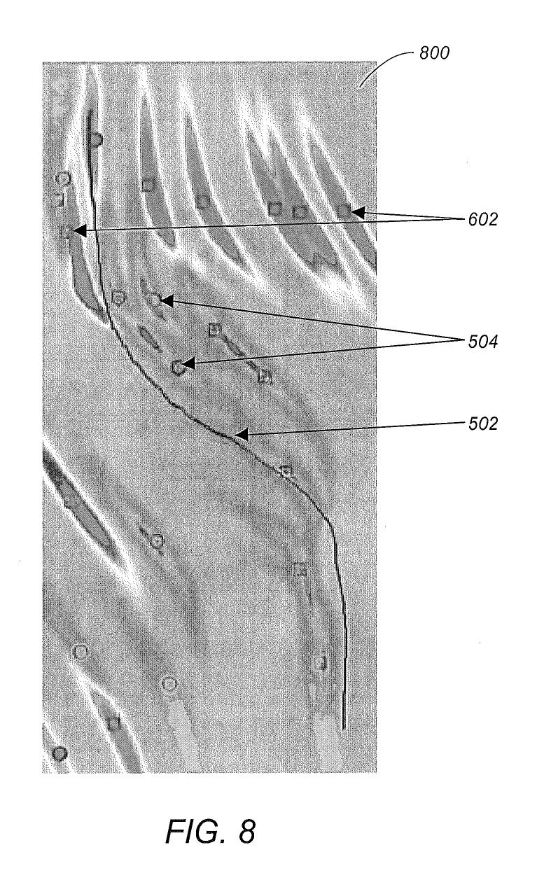

In step 326, the property map displayed in step 317 is automatically updated and displayed using the algorithm selected in step 310 and, as applicable, the variogram parameters selected in step 316, the external histogram input during step 314 (for only unconditional simulation), the azimuth guidelines, if any, drawn in step 320 and the user-defined well data, if any, added during step 324. In FIG. 4B, the property map 400B illustrates an updated display of the property map in FIG. 4A as a result of this step. In FIG. 5, the property map 500 illustrates an updated display, of the property map in FIG. 1B having multiple pre-existing well data points 504 as a result of this step after the addition of four azimuth guidelines 502 during step 320. In FIG. 6, the property map 600 illustrates an updated display of the property map in FIG. 5 as a result of this step after the addition of three user-defined well data points 602 during step 324. In FIG. 7, the property map 700 illustrates an updated display of the property map in FIG. 1B as a result of this step after the addition of four azimuth guidelines 502 during step 320 and one user-defined well data point 602 during step 324. In FIG. 8, the property map 800 illustrates an updated display of the property map in FIG. 1B as a result of this step after the addition of a single azimuth guideline 502 during step 320 and multiple user-defined well data points 602 during step 324. Thus, the method 300 automatically creates simple to complex vector fields, applies them to regionalized properties (petrophysical properties) and displays them in a map view—regardless of the algorithm selected.

In step 328, the method 300 determines if the simulation is finished based upon the results of the property map displayed in steps 317 or 326. If the property map displayed in steps 317 or 326 is acceptable for its intended use, then the simulation may be finished and the method 300 ends. If the property map displayed in steps 317 or 326 is not acceptable for its intended use, then the simulation may not be finished and the method 300 returns to steps 310, 316, 318 or 322. Depending on the results of the property map displayed in steps 317 or 326, the method 300 may be directed by the user to steps 310, 316, 318 or 322.

### System Description

The present invention may be implemented through a computer-executable program of instructions, such as program modules, generally referred to software applications or application programs executed by a computer. The software may include, for example, routines, programs, objects, components, data structures, etc., that perform particular tasks or implement particular abstract data types. DecisionSpace™, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 9, a block diagram illustrates one embodiment of a system for implementing the present invention on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIG. 3. The memory therefore, includes an assisted property modeling module, which enables the methods illustrated and described in reference to FIG. 3 and integrates functionality from the remaining application programs illustrated in FIG. 9. The assisted property modeling module, for example, may be used to execute many of the functions described in reference to steps 312, 314, 316, 317, 318, 320, 322, 324, 326, and 328 in FIG. 3. Decision Space™ may be used, for example, to execute the functions described in reference to steps 302, 304, 308, and 310 in FIG. 3.

Although the computing unit is shown as having a generalized memory, the computing unit typically includes a variety of computer readable media. By way of example, and not limitation, computer readable media may comprise computer storage media The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/non-removable, volatile/nonvolatile computer storage media or they may be implemented in the computing unit through an application program interface (“API”), which may reside on a separate computing unit connected through a computer system or network. For example only, a hard disk drive may read from or write to non-removable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

We claim:

1. A method for updating a property map during a simulation, which comprises:
selecting an algorithm to update the property map based on a conditional simulation or unconditional simulation;
selecting a variogram parameter to update the property map;
updating the property map using the algorithm and the variogram parameter, the updated property map representing a new property map;
rendering an image of the new property map;
drawing an azimuth guideline on the new property map or adding user-defined well data to the new property map;
updating the new property map using the algorithm, the variogram parameter and one of the azimuth guideline and the user-defined well data; and
rendering an image of the updated new property map.

2. The method of claim 1, further comprising repeating the steps in claim 1 until the simulation is finished.

3. The method of claim 4, further comprising rendering an image of the two-dimensional grid or the three-dimensional grid representing the property map.

4. The method of claim 1 wherein the simulation is unconditional simulation.

5. The method of claim 2, further comprising adding an external histogram as input for the unconditional simulation.

6. The method of claim 5 wherein the property map is updated using the algorithm, the variogram parameter and the external histogram.

7. The method of claim 6 wherein the new property map is updated using the algorithm, the variogram parameter, the external histogram and the one of the azimuth guideline and the user defined well data.

8. The method of claim 1 wherein the new property map is updated using the algorithm, the variogram parameter and the azimuth guideline.

9. The method of claim 1 wherein the variogram parameter includes major scale, anistrophy ratio, or global azimuth.

10. The method of claim 2 wherein the property map is updated using the algorithm, the variogram parameter, the external histogram and the one of the azimuth guideline and the user defined well data.

11. A non-transitory program carrier device tangibly carrying computer executable instructions for updating a property map during a simulation, the instructions being executable to implement:
selecting an algorithm to update the property map based on a conditional simulation or unconditional simulation;
selecting a variogram parameter to update the property map;
updating the property map using the algorithm and the variogram parameter, the updated property map representing a new property map;
rendering an image of the new property map;
drawing an azimuth guideline on the new property map or adding user-defined well data to the new property map;
updating the new property map using the algorithm, the variogram parameter and one of the azimuth guideline and the user-defined well data; and
rendering an image of the updated new property map.

12. The program carrier device of claim 11, further comprising repeating the steps in claim 13 until the simulation is finished.

13. The program carrier device of claim 12 further comprising rendering an image of the two-dimensional grid or the three-dimensional grid representing the property map.

14. The program carrier device of claim 12 wherein the simulation is unconditional simulation.

15. The program carrier device of claim 14 further comprising adding an external histogram as input for the unconditional simulation.

16. The program carrier device of claim 15 wherein the property map is updated using the algorithm, the variogram parameter and the external histogram.

17. The program carrier device of claim 16 wherein the new property map is updated using the algorithm, the variogram parameter, the external histogram and the one of the azimuth guideline and the user defined well data.

18. The program carrier device of claim 11 wherein the new property map is updated using the algorithm, the variogram parameter and the azimuth guideline.

19. The program carrier device of claim 11 wherein the variogram parameter includes major scale, anistrophy ratio, or global azimuth.

20. The program carrier device of claim 12 wherein the property map is updated using the algorithm, the variogram parameter, the external histogram and the one of the azimuth guidelines and the user defined well data.
